(19) United States
(12) Patent Application Publication
(10) Pub. No.: US 2006/0014660 A1
(43) Pub. Date: Jan. 19, 2006

(54) Solvent

(76) Inventor: David McCartney, Ribchester (GB)

Correspondence Address: Roberts Abokhair & Mardula, Suite 1000, 11800 Sunrise Valley Drive, Reston, VA, 20191, US

(21) Appl. No.: 10/535,744

(22) PCT Filed: Nov. 12, 2003
(86) PCT No.: PCT/GB03/04860

§ 371 Date: May 20, 2005

(30) Foreign Application Priority Data
Nov. 21, 2002 (GB) 0227207.8

(51) Int. Cl. C11D 17/00

(52) U.S. Cl. 510/421; 510/506

(57) ABSTRACT

A solvent, effective for cleaning paintbrushes, and for cleaning off inks and markers, comprises a solution in water of a non-caustic alkali, a blend of ionic and non-ionic surfactants and a blend of water compatible organic solvents.

This invention relates to solvents, particularly, though not exclusively, for use as paint and paintbrush cleaners, and for cleaning off inks and markers.

Conventional products, such as turpentine substitute and some grades of white spirit, are found to be carcinogenic and/or harmful in other ways, and a safe alternative is required. The present invention provides such an alternative.

The invention comprises a solvent comprising a solution in water of a non-caustic alkali, a blend of ionic and non-ionic surfactants and a blend of water compatible organic solvents.

In one formulation according to the invention, the solvent comprises a solution in water of:
an alkanolamide
a sodium salt of an organic chelate
a non-ionic surfactant
an amphoteric surfactant
a terpenol solvent, and
a glycol ether solvent.

The alkanolamide may be triethanolamide.

The sodium salt may be that of trinitriloacetic acid.

The non-ionic surfactant may be fatty alcohol ethoxylate.

The amphoteric surfactant may be Laurylbetaine.

The terpenol solvent may be D-Limonene.

The glycol ether solvent may be 1-methoxy-2 propanol.

A colorant may be added.

The invention also comprises a method of making a solvent, comprising forming a solution in water of a non-caustic alkali, a blend of ionic and non-ionic surfactants and a blend of water compatible organic solvents.

The solution may be formed at ambient temperature. The product may be stirred to achieve dispersion.

In one method for making a solvent according to the invention, the non-caustic alkali, the surfactants and the organic solvents are added to water in that order.

One example of a solvent and a method for making it according to the invention will now be described.

Formulation:

| | | |
|---|---|---|
| Water | 77.53 | (84.29) |
| Triethanolamide | 2.38 | |
| Trinitriloacetic acid - Sodium salt (40%) | 5.71 | (2.28) |
| Fatty alcohol ethoxylate (6 mole ethoxylate) | 4.76 | |
| Laurylbetaine (30%) | 4.76 | (1.43) |
| D-Limonene (citrus terpine) | 2.36 | |
| 1-methoxy-2-propanol | 2.36 | |
| Yellow dye | 0.10 | |

Figures are % by volume. The sodium salt and the Laurylbetaine are supplied as solutions in water, the active content indicated in brackets. The bracketed water content takes account of this.

This formulation is balanced with citric acid to a pH in the range 9.0 to 9.5.

The product is cold blended at ambient temperature in a stainless steel tank, dispersion being achieved by stirring with a motor driven mixer blade. The materials are added in the order given in the Formulation—this avoids excess froth at an early stage of the process and ensures solubility of the terpenol solvent. After all ingredients are added, the product is mixed for 20 minutes.

It is possible to concentrate the formulation to achieve an active content in the region of 20%, but lesser concentrations are preferred to avoid stability problems in hot or cold storage. It is anticipated that the product will be diluted in use. It will be effective at a dilution of one part to twenty parts water, but for some paints, one part to ten parts water would be recommended.

Various substitutions can be made for the components given in the Formulation. Thus, the sodium salt may be that of ethylene diamide tetraacetic acid. Any of a wide range of non-ionic solvents could be used, for example nonylphenol ethoxylate (8 mole ethoxylated). Sodium xylene sulphonate could be used as the non-ionic surfactant. Other terpinol solvents could be used, such as pine turpinol and synthetic turpene DAB 45. Any of a wide range of glycol ether solvents could be used, including 2-butoxy ethanol (butyl glycol) and dipropylene glycol mono methyl ether (Solvent DPM).

The solvent is effective for the removal and of a wide range of solvent and water based paints, printing inks and markers and cleaning brushes, rollers and other equipment. Within the scope of the invention, solvents can be designed that will be particularly effective against certain types of paint, ink and marker products, but these may be less effective against others.

1. A solvent comprising a solution in water of a non-caustic alkali, a blend of ionic and non-ionic surfactants and a blend of water compatible organic solvents.

2. A solvent comprising a solution in water of:
an alkanolamide;
a sodium salt of an organic chelate;
a non-ionic surfactant;
an amphoteric surfactant;
a terpenol solvent; and
a glycol ether solvent.

3. A solvent according to claim 2, in which the alkanolamide is triethanolamide.

4. A solvent according to claim 2, in which the sodium salt is that of trinitriloacetic acid.

5. A solvent according to claim 2, in which the non-ionic surfactant is fatty acid ethoxylate.

6. A solvent according to claim 2, in which the amphoteric surfactant is Laurylbetaine.

7. A solvent according to claim 2, in which the terpenol solvent is D-Limonene.

8. A solvent according to claim 2, in which the glycol-ether solvent is 1-methoxy-2-propanol.

9. A solvent according to claim 1, containing a colorant.

10. A method for making a solvent, comprising forming a solution in water of a non-caustic alkali, a blend of ionic and non-ionic surfactants and a blend of water compatible organic solvents.

11. A method according to claim 10, in which the solution is formed at ambient temperature.

12. A method according to claim 10, in which the solution is stirred to achieve dispersion.

13. A method according to claim 10, in which the non-caustic alkali, the surfactants and the organic solvents are added to water in that order.

14. A solvent made by a method according to claim 10.

15. (canceled)

16. A solvent comprising a solution in water of:
triethanolamide;
a sodium salt of a trinitriloacetic acid;
fatty acid ethoxylate surfactant;
Laurylbetaine surfactant;
D-Limonene; and
1-methoxy-2-propanol.

17. A solvent according to claim 2, containing a colorant.

18. A solvent according to claim 16, containing a colorant.
